(19) United States
(12) Patent Application Publication
(10) Pub. No.: US 2026/0089691 A1
(43) Pub. Date: Mar. 26, 2026

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Shanghai (CN); Zheng ZHAO, Shanghai (CN)

(21) Appl. No.: 19/410,148

(22) Filed: Dec. 5, 2025

Related U.S. Application Data
(63) Continuation of application No. PCT/CN2024/102084, filed on Jun. 27, 2024.

(51) Int. Cl. H04W 72/04; H04W 28/26

(52) U.S. Cl. CPC H04W 72/04; H04W 28/26

(57) ABSTRACT

Provided are a method and apparatus for wireless communication. One example method includes: receiving, by a first terminal device in a non-terrestrial network (NTN), first information; determining, by the first terminal device, a first resource based on the first information, wherein the first resource is one of a plurality of common preconfigured uplink resources (PURs), and the plurality of common PURs are configured for data transmission in the NTN; and sending, by the first terminal device, first early data transmission (EDT) on the first resource

### CROSS-REFERENCE TO RELATED APPLICATIONS

This application is a continuation of International Application No. PCT/CN2024/102084, filed on Jun. 27, 2024, the disclosure of which is hereby incorporated by reference in its entirety.

### TECHNICAL FIELD

The present disclosure relates to the technical field of communications, and more particularly, to a method and apparatus for wireless communication.

### BACKGROUND

To reduce signaling overhead and power consumption, a terminal device in an idle state may perform early data transmission (EDT) directly via preconfigured uplink resources (PUR), without requiring a random access procedure based on a random access channel (RACH). For example, in a non-terrestrial network (NTN) system, multiple terminal devices may perform RACH-less EDT via PUR.

However, NTN cells face issues such as large coverage areas and long transmission delays. In such scenarios, how the terminal device can perform RACH-less EDT more efficiently becomes a technical problem to be resolved.

### SUMMARY

Embodiments of the present disclosure provide a method and apparatus for wireless communication. Various aspects of the present disclosure are described below.

In a first aspect, a method for wireless communication is provided. The method includes: receiving, by a first terminal device, first configuration information configured for the first terminal device to determine a first resource; and sending, by the first terminal device, a first message on the first resource, wherein the first message is configured to request first EDT, where the first resource is one of a plurality of common PURs, and the plurality of common PURs are configured for data transmission in an NTN.

In a second aspect, a method for wireless communication is provided. The method includes: sending, by a network device, first configuration information configured for a first terminal device to determine a first resource; and receiving, by the network device, a first message on the first resource, where the first message is sent by the first terminal device and configured to request first EDT, the first resource is one of a plurality of common PURs, and the plurality of common PURs are configured for data transmission in an NTN.

In a third aspect, an apparatus for wireless communication is provided. The apparatus is a first terminal device and includes: a receiving unit, configured to receive first configuration information configured for the first terminal device to determine a first resource; and a sending unit, configured to send a first message on the first resource, where the first message is configured to request first EDT, the first resource is one of a plurality of common PURs, and the plurality of common PURs are configured for data transmission in an NTN.

In a fourth aspect, an apparatus for wireless communication is provided. The apparatus is a network device and includes: a sending unit, configured to send first configuration information configured for a first terminal device to determine a first resource; and a receiving unit, configured to receive a first message on the first resource, where the first message is sent by the first terminal device and configured to request first EDT, the first resource is one of a plurality of common PURs, and the plurality of common PURs are configured for data transmission in an NTN.

In a fifth aspect, a communication apparatus is provided. The communication apparatus includes a memory and a processor, where the memory is configured to store a program, and the processor is configured to call the program stored in the memory to perform the method according to the first aspect or the second aspect.

In a six aspect, an apparatus is provided. The apparatus includes: a processor, where the processor is configured to call a program from a memory to perform the method according to the first aspect or the second aspect.

In a seventh aspect, a chip is provided. The chip includes: a processor, where the processor is configured to call a program from a memory to cause a device equipped with the chip to perform the method according to the first aspect or the second aspect.

In an eighth aspect, a computer-readable storage medium is provided. The storage medium stores a program causing a computer to perform the method according to the first aspect or the second aspect.

In a ninth aspect, a computer program product is provided. The computer program product includes: a program causing a computer to perform the method according to the first aspect or the second aspect.

In a tenth aspect, a computer program is provided. The computer program causes a computer to perform the method according to the first aspect or the second aspect.

In the embodiments of the present disclosure, before requesting the first EDT through the first message, the first terminal device needs to determine the first resource for transmitting the first message based on the first configuration information. The first resource is one of multiple common PURs used for NTN communication. It can be seen that in the NTN system, the terminal device can determine the resources for the first EDT in a contention-free manner to reduce conflicts between terminal devices.

### BRIEF DESCRIPTION OF THE DRAWINGS

FIG. 1 is a wireless communication system according to embodiments of the present disclosure.

FIG. 2 is a schematic diagram of a RACH-less EDT procedure.

FIG. 3 is a schematic flowchart of a method for wireless communication according to embodiments of the present disclosure.

FIG. 4 is a schematic flowchart of a possible implementation of the method shown in FIG. 3.

FIG. 5 is a schematic flowchart of another possible implementation of the method shown in FIG. 3.

FIG. 6 is a schematic diagram of an information structure of group signaling.

FIG. 7 is a schematic flowchart of another method for wireless communication according to embodiments of the present disclosure.

FIG. 8 is a schematic diagram of a possible implementation of the method shown in FIG. 7.

FIG. 9 is a schematic structure diagram of an apparatus for wireless communication according to embodiments of the present disclosure.

FIG. 10 is a schematic structure diagram of another apparatus for wireless communication according to embodiments of the present disclosure.

FIG. 11 is a schematic structure diagram of a communication apparatus according to embodiments of the present disclosure.

### DETAILED DESCRIPTION OF THE EMBODIMENTS

The technical solutions in the embodiments of the present disclosure are described in detail hereinafter in conjunction with the accompanying drawings. Apparently. The described embodiments are only a part, but not all, of the embodiments of the present disclosure. With respect to the embodiments in the present disclosure, all other embodiments obtained by a person of ordinary skill in the art without making creative labour fall within the protection scope of the present disclosure.

Embodiments of the present disclosure may be applied to various communication systems. For example, the embodiments of the present disclosure may be applied to a global system of mobile communication (GSM) system, a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of the NR system, a LTE-based access to unlicensed spectrum (LTE-U) system, a NR-based access to unlicensed spectrum (NR-U) system, an universal mobile telecommunication system (UMTS), a wireless local area network (WLAN), wireless fidelity (WiFi), and a fifth-generation communication (5th-generation, 5G) system. The embodiments of the present disclosure may also be applied to other communication systems, such as a future communication system. The future communication system may for example be a 6th-generation (6G) mobile communication system, or a satellite communication system.

A conventional communication system supports a limited number of connections, which are easy to implement. However, with the development of communication technology, a communication system can support not only a conventional cellular communication, but also one or more other types of communications. For example, the communication system may support one or more of the following communications: device to device (D2D) communication, machine to machine (M2M) communication, machine type communication (MTC), enhanced MTC (eMTC), vehicle to vehicle (V2V) communication, vehicle to everything (V2X) communication and the like. The embodiments of the present disclosure may also be applied to a communication system supporting the above communications.

A communication system in the embodiments of the present disclosure may be applied in a carrier aggregation (CA) scenario, a dual connectivity (DC) scenario, and a standalone (SA) network deployment scenario.

The communication system in the embodiments of the present disclosure may be applied to unlicensed spectrum. The unlicensed spectrum may also be considered as shared spectrum. Alternatively, the communication system in the embodiments of the present disclosure may be applied to licensed spectrum. The licensed spectrum may also be considered dedicated spectrum.

The embodiments of the present disclosure may be applied to a terrestrial network (TN) system or a non-terrestrial network (NTN) system. As an example, the NTN system may include a 4G-based NTN system, a NR-based NTN system, an internet of things (IoT)-based NTN system, or a narrow band internet of things (NB-IoT)-based NTN system.

The communication system may include one or more terminal devices. The terminal device in the embodiments of the present disclosure may also be referred to as a user equipment (UE), an access terminal, a subscriber unit, a subscriber station, a mobile, a mobile station (MS), a mobile terminal (MT), a remote station, a remote terminal, a mobile device, a user terminal, a terminal, a wireless communication device, a user agent, a user apparatus, or the like.

In some embodiments, the terminal device may be a station (ST) in a WLAN. In some embodiments, the terminal device may be a cellular telephone, a cordless telephone, a session initiation protocol (SIP) telephone, a wireless local loop (WLL) station, a personal digital assistant (PDA) device, a handheld device with wireless communication function, a computing device, or another processing device connected to a wireless modem, an in-vehicle device, a wearable device, a terminal device in a next generation communication system (e.g., an NR system), or a terminal device in a future evolved public land mobile network (PLMN) network, or the like.

In some embodiments, the terminal device may refer to a device that provides voice and/or data connectivity for a user. For example, the terminal device may be a handheld device or a vehicle-mounted device having a wireless connection function. As some concrete examples, the terminal device may be a mobile phone, a pad, a laptop, a palmtop, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like.

In some embodiments, the terminal device may be deployed on land. For example, the terminal device may be deployed indoors or outdoors. In some embodiments, the terminal device may be deployed on water, such as on a ship. In some embodiments, the terminal device may be deployed in the air, such as on an aircraft, a balloon, or a satellite.

In addition to the terminal device, the communication system may include one or more network devices. The network device in the embodiments of the present disclosure may be a device for communicating with the terminal device, and may also be referred to as an access network device or a wireless access network device. The network device may be a base station, for example. The network device in the embodiments of the present disclosure may refer to a radio access network (RAN) node (or device) that accesses the terminal device to a wireless network. A base station may broadly cover various names in the following, or be substituted with the following names, such as: node B (NodeB), evolved NodeB (eNB), next generation NodeB (gNB), relay station, access point, transmitting and receiving point (TRP), transmitting point (TP), primary MeNB, secondary SeNB, multi-standard radio (MSR) node, home base station, network controller, access node, wireless node, access point (AP), transmission node, transmitting and receiving node, base band unit (BBU), remote radio unit (RRU), active antenna unit (AAU), remote radio head (RRH), central unit (CU), distributed unit (DU), positioning node and so on. The base station may be a macro base station, a micro base station, a relay node, a giver node, or the like, or a combination thereof. The base station may also refer to a communication module, modem or chip disposed within the aforementioned equipment or device. The base station may also be a mobile switching center, a device assuming a base station function in D2D, V2X, M2M communications, a network side device in a 6G network, a device assuming a base station function in a future communication system, or the like. The base station may support networks with the same or different access technologies. The embodiments of the present disclosure do not limit specific technologies and specific device form used in the network device.

The base station may be fixed or mobile. For example, a helicopter or drone may be configured to act as a mobile base station, and one or more cells may be moved according to the location of the mobile base station. In other examples, the helicopter or drone may be configured to be used as a device for communicating with another base station.

In some deployments, the network device in the embodiments of the present disclosure may refer to a CU or a DU, or the network device includes a CU and a DU. gNB may also include an AAU.

By way of example and not as a limitation, in the embodiments of the present disclosure, the network device may have mobile characteristics. For example, the network device may be a mobile device. In some embodiments of the present disclosure, the network device may be a satellite, or a balloon station. In some embodiments of the present disclosure, the network device may also be a base station disposed on land, water, or the like.

In some embodiments of the present disclosure, the network device may provide services for a cell, and the terminal device communicates with the network device through the transmission resources (e.g., frequency domain resources, or spectrum resources) used by the cell. The cell may be a cell corresponding to the network device (e.g., a base station), and the cell may belong to a macro base station, or may belong to a base station corresponding to a small cell, where the small cell may include: metro cell, micro cell, pico cell, femto cell, etc. These small cells have characteristics of small coverage area and low transmit power, and are suitable for providing high speed data transmission services.

Exemplarily, FIG. 1 shows a schematic diagram of an architecture of a communication system according to embodiments of the present disclosure. As shown in FIG. 1, the communication system 100 may include a network device 110, and the network device 110 may be a device that communicates with a terminal device 120 (or referred to as a communication terminal or a terminal). The network device 110 may provide communication coverage for a specific geographic area and may communicate with a terminal device located within the coverage area.

FIG. 1 exemplarily illustrates one network device and two terminal devices, and in some embodiments of the present disclosure, the communication system 100 may include a plurality of network devices and may include other numbers of terminal devices within the coverage area of each of the network devices, which is not limited in the embodiments of the present disclosure.

In the embodiments of the present disclosure, the wireless communication system shown in FIG. 1 may also include a mobility management entity (MME), an access and mobility management function (AMF), and other network entities, which is not limited in the embodiments of the present disclosure.

It should be understood that a device having a communication function in the network/system in the embodiments of the present disclosure may be referred to as a communication device. Taking the communication system 100 illustrated in FIG. 1 as an example, the communication device may include a network device 110 and a terminal device 120 having a communication function, and the network device 110 and the terminal device 120 may be specific devices as described above, which are not repeated herein. The communication device may also include other devices in the communication system 100, such as a network controller, a mobile management entity, and other network entities, which is not limited in the embodiments of the present disclosure.

In order to facilitate understanding, some relevant technical knowledge involved in the embodiments of the present disclosure is first introduced. The following related technologies may be arbitrarily combined with the technical solutions of the embodiments of the present disclosure as optional solutions, which all fall within the protection scope of the embodiments of the present disclosure. The embodiments of the present disclosure include at least some of the following contents.

In the development of communication technology, reducing signaling overhead and power consumption has always been an important research topic. For example, in the 3rd Generation Partnership Project (3GPP) Release 15 (Rel-15), the EDT functionality is introduced for NB-IoT and eMTC systems. The EDT functionality enables a terminal device in a radio resource control (RRC) idle (IDLE) mode to directly transmit data via Message 3 (Msg3) in a random access procedure. In other words, the terminal device can transmit data without switching from the RRC idle mode to an RRC connected mode, thereby reducing signaling overhead and power consumption for related communication devices. For example, in Release 16 (Rel-16), the introduction of the PUR mechanism further enhances the early transmission of uplink (UL) data. The PUR mechanism allows the eNB to configure dedicated uplink resources for terminal devices. These uplink resources may include physical uplink shared channel (PUSCH) resources.

In some embodiments, EDT can be applied to a four-step random access procedure. Specifically, a terminal device and a network device can complete the EDT-based four-step random access procedure through message 1 (Msg1) to message 4 (Msg4). For example, the terminal device and the network device transmit EDT-specific Message 1, a random access response (RAR), an RRC early data request (RRCEarlyDataRequest) message (Msg3), and an RRC early data complete (RRCEarlyDataComplete) message (Msg4).

In some embodiments, the terminal device in the idle mode can utilize the PUR configured by the network device to send UL data without executing the random access procedure. For example, the terminal device can directly send the RRCEarlyDataRequest message and receive the RRCEarlyDataComplete message, i.e., transmitting messages 3 and 4. By skipping the transmission of message 1 and RAR in the random access procedure, the transmission efficiency of the uplink can be improved, and the power consumption of the terminal device can be further reduced.

In the above embodiments, the EDT that does not require the random access procedure can also be referred to as RACH-less EDT. The RACH-less EDT in the embodiments of the present disclosure can be applied to NTN cells as well as terrestrial network (TN) cells. However, introducing RACH-less EDT enhancements is more meaningful in NTN.

First, compared with TN cells, NTN cells have a much larger coverage area. For example, IoT NTN must support a massive capacity of terminal devices. Furthermore, NTN typically has a very long round-trip time (RTT). Therefore, the cost of restarting the entire RACH process in NTN is too high. After introducing RACH-free EDT, directly transmitting message 3 without messages 1 and 2 can effectively save signaling overhead caused by messages 1 and 2.

Second, the terminal device typically has global navigation satellite system (GNSS) capabilities, meaning that the terminal device knows its own location before accessing the NTN cell. Additionally, terminal devices can determine a position of a satellite, for example, by using ephemeris table information broadcast in the system information block (SIB). Based on the terminal device's location and the satellite's position, the terminal device can determine an effective timing advance (TA) using these two values. When the terminal device has an effective timing alignment value, RACH-less EDT can be enabled.

In summary, when using RACH-less EDT to achieve access in an NTN system, signaling overhead and power consumption can be effectively reduced.

The use cases and activation conditions for RACH-less EDT have certain requirements. In other words, terminal devices in the cell that meet the conditions can enable RACH-less EDT to reduce signaling overhead. In some embodiments, the application scenarios for RACH-less EDT can include upper-layer requests to establish or restore an RRC connection, or requests to establish or restore an initial call. In some embodiments, the activation conditions for RACH-less EDT include the terminal device having a valid timing alignment value, and/or a size of a media access control (MAC) protocol data unit (PDU) obtained at a MAC layer being expected to be no larger than a transport block size (TBS) configured by the system for RACH-less EDT. The activation of RACH-less EDT requires meeting but is not limited to the above conditions.

For ease of understanding, the following exemplarily describes of the RACH-less EDT process in conjunction with FIG. 2. FIG. 2 is presented from the perspective of interaction between a terminal device and a network device. The terminal device may be a UE, and the network device may be a network-side device of the NTN.

Referring to FIG. 2, in operation S210, the terminal device sends an RRC early data request (EarlyDataRequest) message to the network device. This message typically includes a resume identity (ID), establishment cause, and non-access stratum (NAS) dedicated information (dedicatedinfoNAS).

In operation S220, the network device uses an MAC control element (MAC CE) carrying a channel state information reference signal resource indicator (CSI-RS RI, CRI) to feedback the RRC early data completion (EarlyDataComplete) to the terminal device.

The above describes a flowchart of the RACH-less EDT in conjunction with FIG. 2.

In an actual communication system, if a terminal device is configured with PUR but does not need to initiate the PUR process, the pre-configured uplink resources will be wasted. This issue is more pronounced in NTN systems. There are a large number of terminal devices within an NTN cell, making it difficult to configure dedicated uplink resources for all the terminal devices. If uplink resources are pre-configured, a large number of terminal devices not performing uplink transmission will result in significant waste. To address this issue, multiple terminal devices can share uplink resources. For example, PUR may be a shared public resource. Multiple terminal devices initiating RACH-less EDT may transmit Message 3 over shared uplink resources to improve resource utilization efficiency and capacity.

However, sharing the uplink resources for transmission of Message 3 may increase the risk of conflicts between different terminal devices. For example, multiple terminal devices may initiate RACH-less EDTs and use the same time-frequency resources to simultaneously transmit Message 3. If the conflict rate is high, negative impacts, such as increased signaling overhead and terminal device power consumption, may occur. Nevertheless, in NTN, particularly NB-IoT on NTN, spectrum (also known as frequency resources) is scarce and expensive. Therefore, in such scenarios, the effective design and/or specification of RACH-less EDT, such as transmission of message 3 without message 1, is critical.

In summary, how the terminal device can more efficiently execute the RACH-free EDT in a scenario such as NTN is a technical issue worth studying.

It should be noted that the issue mentioned above, where extended transmission times and a large number of service terminals in NTN systems lead to conflicts in the use of shared EDT resources, is merely an example. The embodiments of the present disclosure may be applied to any type of communication scenario where conflicts in shared EDT resources occur.

Based on this, the embodiments of the present disclosure provide a method for wireless communication. Through this method, the first terminal device can send a first message on the first resource to request the first EDT. During this communication process, the network device and the first terminal device may determine a first wireless network temporary identifier (RNTI) related to the first terminal device based on configuration or information related to the first resource. The first RNTI may be configured to identify the first terminal device and the first message sent by the first terminal device. Based on different RNTIs, multiple terminal devices can share multiple common PURs including the first resource.

In some embodiments, the first EDT may include the transmission of uplink data or information when the first terminal device is in an idle state. For example, the first EDT may be replaced with a first RACH-less EDT or a first RACH-less EDT.

As an example, the first EDT may be configured to send an update message for the TA.

As an example, the first EDT may be initiated for data transmission or for voice calls, which is not limited here.

As an example, multiple TBS corresponding to the first EDT may be configured to transmit multiple uplink data of different sizes.

As an example, the first EDT may be an NTN RACH-less EDT. For example, when supporting the NTN RACH-less EDT, the communication device can use pre-configured orthogonal cover code (OCC) narrowband physical random access channel (NPRACH) resources to skip message 1 and message 2.

In the embodiments of the present disclosure, “requesting the first EDT” may be replaced with “performing the first EDT,” or “requesting access via the first EDT.” That is, the first terminal device may indicate a request for the first EDT by directly performing the first EDT. Alternatively, the first message may be used by the first terminal device to request access. Requesting access may also be referred to as requesting an RRC connection.

In some embodiments, the first terminal device may request the first EDT via the first message or directly perform the first EDT via the first message. When the first terminal device requests the first EDT via the first message, the first message may include request information for the first EDT. When the first terminal device performs the first EDT via the first message, the first message may include data to be transmitted corresponding to the first EDT.

In some embodiments, the first terminal device may also perform the first EDT while requesting the first EDT. In other words, the first message may include both the request information and the data to be transmitted corresponding to the EDT.

The first resource is one of multiple common PURs. The multiple common PURs refer to PURs configured by the network device as shared public resources. As mentioned earlier, configuring PURs as shared uplink resources for multiple terminal devices can prevent resource waste. In certain scenarios, PURs are primarily configured for transmission of PUSCH, so PURs may also be referred to as PUSCH resources. That is, multiple common PURs may serve as PUSCH resources used simultaneously by multiple terminal devices.

In some embodiments, multiple common PURs may be all or part of time-frequency resources in one pre-configured resource pool, or time-frequency resources in multiple pre-configured resource pools, which is not limited here. For example, multiple common PURs are at least time-frequency resources.

As an example, pre-configured multiple common PUR resources may be configured for each cell and shared by multiple terminal devices.

As an example, multiple common PURs may be PUR resources for a physical random access channel (PRACH). For example, for supporting the NTN RACH-less EDT, PUSCH resources corresponding to the PRACH may be used.

In some embodiments, multiple common PURs may be configured based on a number of terminal devices within a cell, a number of terminal devices sending a request, or a size of the uplink resources.

In some embodiments, the network device may indicate multiple common PURs to the terminal device using various methods. In an embodiment, the network device may actively send configuration information for multiple common PURs, or indicate configuration information for multiple common PURs based on the terminal device's request.

As an example, the network device may provide multiple common PURs and/or configuration information for multiple common PURs via the SIB. For example, the broadcast channel in the SIB may be configured to broadcast configuration information for multiple common PURs.

As an example, a network side may send multiple common PURs and/or configuration information for multiple common PURs via RRC dedicated signaling (also known as proprietary signaling). For example, the RRC dedicated signaling is an RRC connection release (RRCConnectionRelease) message.

As an example, the network device may broadcast configuration of multiple common PURs in a SIB, or use RRC release (RRCRelease) to configure multiple common PURs. As an example, the network device may broadcast multiple common PURs in an SIB and configure other information in an RRCRelease. Other information includes, for example, a TA timer (TAT), TA, a cell RNTI (C-RNTI), an RRC message, and other downlink (DL) data.

As an example, when a terminal device initially accesses the network, if random access is successful, indices of multiple common PURs for the EDT may be carried in an SIB message, or in an RRC message during the random access procedure, or in DCI information.

As an example, the network device may send multiple common PURs and resource configuration information based on the terminal device's request. For example, in an NTN system, the first terminal device may trigger a resource configuration request to request the NTN to provide configuration information for multiple common PURs.

In some embodiments, the configuration of multiple common PURs may be configured for a service cell where the first terminal device is located and/or a neighboring cell. In certain scenarios, although PURs are shared resources, they may still be specific to the terminal device or specific to the cell. In an NTN system, once a satellite moves out of the current area and a new satellite joins the service, the configuration of the PUR becomes ineffective. Based on this, the configuration of multiple common PURs can be applicable across multiple cells, thereby avoiding the need for the terminal device to enter an RRC connection mode to obtain the configuration for each new cell.

As an example, the configuration of multiple common PURs may be applicable to a service cell providing the PUR configuration.

As an example, the configuration of multiple common PURs may be applicable to a service cell providing the PUR configuration and other cells other than the service cell.

As an example, multiple common PURs are located in a PUR shared resource pool, or multiple common PURs form a PUR shared resource pool.

In some embodiments, multiple common PURs may be allowed to appear periodically. That is, resource sizes of multiple common PURs may be repetitive, especially when multiple common PURs are configured in the SIB. Specifically, if the network side provides common PURs with multiple repetitive sizes, it is necessary to configure corresponding conditions for the terminal device to select the multiple common PURs.

In some embodiments, if the configuration of the multiple common PURs is provided in the system information, the scheme in the embodiments of the present disclosure is effective for all types of terminal devices, including the terminal device accessing the network for the first time.

In some embodiments, the terminal device may select requesting the first EDT or uplink resources for the first EDT through various methods. Exemplarily, the first terminal device may determine a corresponding first resource based on the configuration of the network device. In this scenario, the network device needs to configure the corresponding first resource for multiple terminal devices among multiple common PURs. This method of determining the first resource may also be referred to as a contention-free method or a competition-free method. For example, the first terminal device may directly select the first resource from multiple common PURs. In this scenario, multiple terminal devices may select the first resource, and the network device needs to determine whether the first terminal device successfully selected the first resource, and provide feedback. This method of determining the first resource may also be referred to as a contention-based (or competitive) method.

In some embodiments, based on the method by which the terminal devices select uplink resources from multiple common PURs, multiple common PURs may be configured as contention-free shared (CFS) pre-configured UL resources (CFS PURs) and/or contention-based shared (CBS) pre-configured UL resources (CBS PURs).

As an example, multiple common PURs may include multiple CFS PURs, or multiple common PURs may be multiple CFS PURs. Since the CFS PURs are contention-free, multiple terminal devices including the first terminal device determine uplink resources based on the contention-free method.

As an example, multiple common PURs may include multiple CBS PURs, or multiple common PURs may be multiple CBS PURs. Since the CBS PURs are contention-based, multiple terminal devices including the first terminal device may select resources based on a contention resolution scheme to determine uplink resources.

As an example, multiple common PURs may include multiple CFS PURs and multiple CBS PURs. For example, multiple terminal devices may be divided into two groups based on the resource selection method, and the two groups respectively determine uplink resources using different methods. For example, multiple terminal devices may prioritize selecting resources from CFS PURs using the contention-free method. When the remaining resources in CFS PURs are insufficient, multiple terminal devices may select resources from CBS PURs using the contention-based method. For example, multiple terminal devices may prioritize selecting resources from CBS PURs using the contention-based method. When the remaining resources in the CBS PURs are insufficient, the multiple terminal devices select resources from the CFS PURs using the contention-free method.

In some embodiments, the first resource may be one of the contention-free PURs or one of the contention-based PURs. Regardless of the method configured to determine the uplink resource, the uplink resource is the first resource for sending the first message.

In some embodiments, if contention-based PURs are supported, the network device must configure one or more CBS PURs. If contention-free PURs are supported, the network device must configure one or more CFS PURs. For example, in an NTN cell, multiple contention-based common PURs may be introduced for different coverage levels, coverage areas, and/or different carriers within the cell.

In some embodiments, when the first resource is based on a contention-free PUR, the first terminal device needs to send a resource request to determine a corresponding first resource. When the first resource is based on a contention-based PUR, the network device needs to determine whether the terminal device contesting the first resource is the first terminal device and provide feedback. For ease of understanding, the following provides specific explanations in conjunction with multiple embodiments.

### Embodiment 1

In this embodiment, the first terminal device selects the first resource from multiple common PURs using a contention-based resolution method. That is, the first resource is one of the contention-based multiple common PURs (CBS PUR). The first resource is configured to send an EDT or an EDT request. For this method, the network device does not know which terminal device will select which resource from the multiple common PURs to send the EDT request.

To address this issue, the present disclosure proposes a method for wireless communication. When a first terminal device sends a first message on a first resource, a network device can determine which terminal device a first EDT requested in the first message originates from based on a first RNTI. The first RNTI may be associated with the first resource, or carried within the first message. Based on this method, the network device can determine which terminal device each received EDT request originates from and provide feedback, thereby reducing conflicts between different terminal devices.

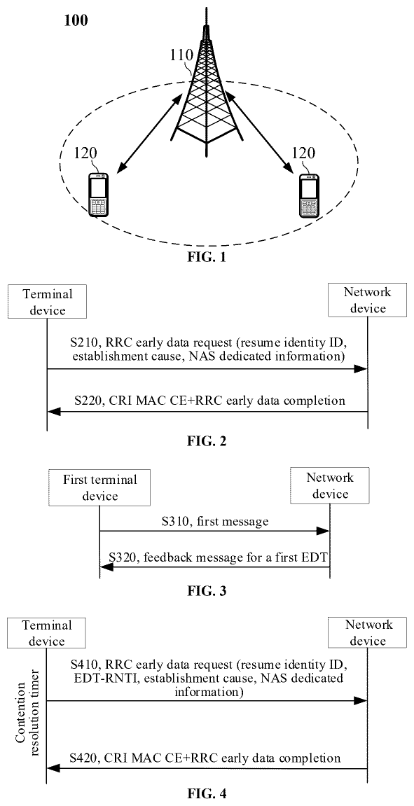

For ease of understanding, the method for wireless communication according to the present disclosure is described in detail below with reference to FIG. 3. FIG. 3 is presented from the perspective of interaction between a first terminal device and a network device. The first terminal device may be any of the communication terminals described above, such as a UE. The network device may be any of the access network devices or core network devices described above, such as gNB or eNB.

In some embodiments, the first terminal device may be a terminal device that performs uplink transmission to the network device, or a terminal device that receives downlink transmission from the network device, which is not repeated here.

In some embodiments, the first terminal device may be a terminal device in a network with relatively long communication latency. In an embodiment, the first terminal device may be a terminal device in an NTN system. That is, a service cell in which the first terminal device is located is an NTN cell. Alternatively, the first terminal device may be a ground terminal in an NTN cell. As an example, the first terminal device may be a terminal in an NB-IoT system.

As an example, the first terminal device may be located within the coverage area of a satellite. For example, the first terminal device may be an NTN IoT terminal.

In some embodiments, the first terminal device may be a terminal device that performs lateral transmission to other terminal devices.

In some embodiments, the network device may be any type of device on the network side of a communication system. The communication system is, for example, an NTN system.

As an example, the network device may include a satellite in the NTN system, and the first terminal device is a terminal device in a cell that provides services to the satellite. For example, when a base station is deployed on the satellite, the first terminal device may communicate directly with the base station on the satellite. For example, when the satellite acts as a relay, the first terminal device may communicate with the network device on the ground via the satellite.

As an example, when the network device includes a satellite, the first terminal device may be located within the service area of the satellite at the current time to transmit or receive data via the satellite.

In some embodiments, the first terminal device is a terminal currently in an idle state (also referred to as idle mode). That is, at the current time, the first terminal device is not in an RRC connection state with the network device.

In some embodiments, the first terminal device may be one of multiple terminal devices within the same service cell. All the multiple terminal devices may execute the method according to the embodiments of the present disclosure. For example, multiple terminal devices may each send a first message requesting EDT.

Referring to FIG. 3, in operation S310, the first terminal device sends a first message on the first resource. Correspondingly, the network device receives the first message on the first resource.

The first message may include different types of messages or one or more pieces of information, which is not repeated here.

In some embodiments, the first message may be an uplink message during the random access procedure. For example, the first message may be message 3 in the RACH-less access procedure. In the RACH-less access procedure, the first terminal device skips the transmission of message 1 and the reception of message 2 during the random access procedure and directly sends message 3. Since transmission of message 3 skips message 1 and RAR, the first terminal device does not receive the RNTI information in RAR before receiving message 4, and cannot determine the transmission resources for message 3 via RAR.

As an example, the first message is a non-RACH message directly sent by the first terminal device to the network device in an idle mode. Therefore, the first message may be a message for PUSCH sent by the first terminal device for the first time.

The first message is configured to request the first EDT, and thus may include the corresponding request. In some embodiments, the first terminal device may send an early data request to the network device via the first message to enable uplink data transmission in scenarios where an RRC connection has not been established.

As an example, the first message may be configured by the first terminal device to perform an upper-layer establishment request or to resume an RRC connection. For example, the first message may include an RRC connection resume request (RRCConnectionResumeRequest).

As an example, the first message may be configured by the first terminal device to establish or resume a connection for initiating a call.

As an example, the first message may include an early data request, such as an RRCEarlyDataRequest.

As an example, the first message may include data requiring early transmission. For example, the first terminal device may send UL data along with the RRCEarlyDataRequest or RRCConnectionResumeRequest in the first message.

As described above, the network device may configure multiple shared common PURs for multiple terminal devices. To facilitate the identification of first messages sent by multiple terminal devices via multiple common PURs, the multiple common PURs can correspond to multiple RNTI. It should be noted that the present disclosure provides a novel RNTI for multiple common PURs to uniquely identify the transmission of the first message.

In some embodiments, multiple RNTI are configured to identify EDT requests or multiple common PURs sent by multiple terminal devices, so multiple RNTI may be multiple EDT-RNTI or multiple PUR-RNTI.

The multiple RNTI include a first RNTI configured for the network device to determine that the first EDT corresponds to the first terminal device. That is, when the network device receives the first EDT or a request for the first EDT, the network device can determine that the first EDT originates from the first terminal device based on the first RNTI, so as to provide feedback (via the feedback message for the first EDT) and implement contention-based resource allocation.

As an example, the first RNTI may be the first EDT-RNTI, or the first RNTI may be the first PUR-RNTI.

The first RNTI may be the RNTI corresponding to the first resource or the RNTI in the first message. In other words, the first RNTI corresponds to the first resource, or the first message includes the first RNTI. When the first RNTI corresponds to the first resource, the network device can determine that the terminal device requesting the first EDT is the first terminal device based on the first resource. When the first message includes the first RNTI, the network device can determine that the terminal device selecting the first resource or requesting the first EDT is the first terminal device based on the first message.

As an example, the first RNTI may be configured to identify the first resource, i.e., the time-frequency resource for sending the first message.

In some embodiments, the first terminal device may determine the first RNTI in various ways. In an embodiment, the first terminal device may use two methods to obtain the RNTI of message 4 related to CBS PUR: through network (NW) configuration or by performing calculations by the network device itself. The network device uses this RNTI to feedback the request or transmission of the first EDT in the first message.

As an example, the first terminal device may determine the first RNTI based on the configuration of the network device. For example, the network-side device may allocate RNTI through an RRCConnectionRelease message. That is, the NW can allocate an EDT-RNTI specific to the first terminal device. The first terminal device can confirm the corresponding first RNTI based on the connection release message while in the connected state.

As an example, when the first terminal device determines the first RNTI based on the network configuration, the first terminal device may select the first resource based on the first RNTI. When the first RNTI is the first EDT-RNTI, multiple EDT-RNTI including the first EDT-RNTI are associated with the indices of multiple common PURs. That is, the network device configures which common PUR is used by which EDT-RNTI.

As an example, the first terminal device may calculate the first RNTI based on the configuration of multiple common PURs. For example, the network device may configure multiple common PURs via the SIB, and the first terminal device may calculate the first RNTI based on this configuration and monitor the physical downlink control channel (PDCCH) carrying a feedback message.

As an example, the first terminal device determines the first RNTI based on the configuration of multiple common PURs and the first resource. For example, the first RNTI is determined based on the PUSCH time-frequency resources (first resource) of the first message. For example, after the base station configures the PUR shared resource pool, each resource block has a corresponding EDT-RNTI. When the first terminal device sends the first message using the first resource, the first EDT-RNTI is calculated based on the first resource and stored for monitoring.

In some embodiments, the network device may also determine the first RNTI in various ways. In an embodiment, after the network device receives the first message on the first resource, the network device may determine the first RNTI based on the first resource or the first message.

As an example, when the network device configures the first RNTI for the first terminal device, the first RNTI may be carried in the first message. After the network device receives the first message, the network device determines that the first EDT originates from the first terminal device. For example, after receiving the first RNTI configured by the network device, the first terminal device may select the first resource for sending the first message based on the configured first RNTI.

As an example, after receiving the first message on the first resource, the network device may determine the first RNTI based on the first resource. For example, after receiving the message 3, the base station also calculates the EDT-RNTI to obtain the first RNTI. The base station may scramble the cyclic redundancy check (CRC) of downlink control information (DCI) Format 1_0 for Message 4 (including feedback information of the first EDT) using the first RNTI. Only a terminal device that sends the first message on a time-frequency resource (the first resource) identified by the first RNTI can decode this PDCCH DCI.

In some embodiments, multiple common PURs may be configured for multiple terminal devices. The first RNTI may be determined based on a position of the first resource in multiple common PURs and/or a terminal device set in which the first terminal device is included.

As an example, when the first terminal device is a terminal device j in terminal device set i, the first RNTI is:

$$EDT - RNTI ( i , j ) = 1 + {s}_{id} ( i , j ) + 14 \times {t}_{id} ( i , j ) + 14 \times M ( i ) \times {f}_{id} ( i , j ) + 14 \times M ( i ) \times N ( i ) \times {ul}_{carrier , id} .$$

s_{id}(i,j) denotes an index of a symbol corresponding to the terminal device j among multiple common PURs, t_{id}(i,j) denotes an index of a slot corresponding to the terminal device j among the multiple common PURs, f_{id}(i,j) denotes an index of a frequency domain resource corresponding to the terminal device j among the multiple common PURs, M(i) denotes a number of slots in the terminal device set i, N(i) denotes a number of frequency domain resources in the terminal device set i, and ul_{carrier,id} denotes an index of a uplink carrier corresponding to the first message.

In an embodiment, the symbols in the above formula are orthogonal frequency division multiplexing (OFDM) symbols.

In an embodiment, s_{id}(i,j) is one of s_{id}, where 0≤s_{id}<14.

In an embodiment, M may be a maximum number of slots corresponding to multiple terminal device sets, and t_{id}(i,j) is one of t_{id}, where 0≤t_{id}<M.

In an embodiment, N is a maximum number of frequency domain resources, and f_{id}(i,j) is one of f_{id}, where 0≤f_{id}<N.

In an embodiment, for a normal uplink (NUL) carrier, a value of ul_{carrier,id} is 0; and for a supplementary uplink (SUL) carrier, a value of ul_{carrier,id} is 1.

In some embodiments, the first terminal device is one of multiple terminal devices within the NTN cell requesting EDT. Since the number of terminal devices within the NTN cell is very large, multiple terminal devices requesting EDT or multiple terminal devices within the cell may be divided into multiple terminal device sets. Multiple RNTI including the first RNTI may be associated with multiple terminal device sets. That is, dividing multiple terminal devices into multiple terminal device sets can facilitate terminal devices and network devices in better determining the corresponding RNTI.

In some embodiments, the multiple terminal device sets may be determined based on one or more of the following information: service types of the multiple terminal devices; service times of the multiple terminal devices; location information of the multiple terminal devices and/or multiple sub-regions of the NTN cell.

As an example, the first RNTI configured by the network device is associated with a terminal device set in which the first terminal device is included. The terminal device set in which the first terminal device is included is determined based on one or more of the following information: a service type of the first terminal device; a service time of the first terminal device; location information of the first terminal device and/or multiple sub-regions of the NTN cell.

For ease of understanding, the following exemplarily describes various implementations using multiple EDT-RNTI as an example.

As one implementation, the terminal device set in which the first terminal device is included may be determined based on the service type of the first terminal device. In this scenario, the network device performs division of terminal device sets based on the service types of multiple terminal devices. Correspondingly, the network side may configure specific-purpose EDT-RNTIs for different terminal device sets. For example, all EDT-RNTIs may be divided into multiple groups, with each group corresponding to a specific service type. When one service type uses one EDT-RNTI group, service type-specific EDT-RNTIs can conserve resources required by the network device for blind decoding of multiple first messages. Taking message 3 as an example, the network device does not know which terminal device sent message 3, but knows a service type of the terminal device. In this implementation, the network device only needs to use the EDT-RNTI group corresponding to the service type to blindly decode the received message 3, rather than using all EDT-RNTI for blind decoding.

As another implementation, the terminal device set in which the first terminal device is included may be determined based on the service time of the first terminal device. The service time of the first terminal device may represent a remaining time of the first terminal device in the current service or a remaining service time of a current satellite. The network device may set multiple service time thresholds to divide multiple terminal devices into multiple terminal device sets. The network device may allocate EDT-RNTI groups based on the service time of each terminal device set. When the terminal device set in which the first terminal device is included corresponds to a shorter service time, the first terminal device may use time-frequency resources with an earlier time-domain position.

As another implementation method, the terminal device set in which the first terminal device is included may be determined based on the location information of the first terminal device and/or multiple sub-regions of the NTN cell. The NTN cell may be divided into multiple sub-regions (also referred to as sub-cells). Within the NTN cell, different sub-regions are located at varying distances from the cell edge. For example, multiple terminal devices located in close proximity may be grouped into a single terminal device set. For example, multiple terminal devices within the same sub-region may be grouped into a single terminal device set. That is, a number of the terminal device sets is the same as a number of the sub-regions. Each sub-region is assigned a region ID. One region ID is provided for one group of terminal devices, and each group of terminal devices is assigned one set of EDT-RNTI.

In the above implementation, the NTN cell is divided into multiple sub-regions in a circular manner. The network device may group multiple terminal devices based on the sub-region ID and the location of the terminal devices, and generate a set of EDT-RNTI for each group of terminal devices.

In the above implementation, multiple common PURs are configured for terminal devices within multiple sub-regions. Therefore, multiple sub-regions may correspond to multiple common PUR sets. Sizes of the multiple common PUR sets are determined based on a number of sub-regions and/or a distance between each sub-region and an edge of the NTN cell. Due to the large coverage area and region of NTN, NTN may achieve resource reuse among multiple terminal devices based on multiple sub-regions while sharing PURs. Multiple common PURs may be divided based on sub-regions to form multiple common PUR sets. A common PUR corresponding to a sub-region is only used by terminal devices within that sub-region.

As an example, when a number of sub-regions is large, the size of each common PUR set within the multiple common PUR sets is relatively small.

As an example, when a distance between a certain sub-region and the edge of the NTN cell is relatively small, a common PUR set corresponding to that sub-region is smaller.

As an example, multiple common PUR sets may be represented as the previously mentioned M(i). A magnitude of M(i) may be related to an ID of a corresponding sub-region. Multiple common PURs may first be evenly divided based on the number of region IDs, with each region allocated M_{average} time slots. The size of each group's M(i) may be M(i)=(1/Q)×M_{average}, where Q represents an expansion factor, and is a rational number. Q=1 indicates that resources are equally partitioned.

As an example, a common PUR set corresponding to each sub-region may be sent to all terminal devices within the NTN sub-region via multicast. For example, the NTN may broadcast information about the sub-region ID to all terminal devices, and a terminal device may determine its sub-region based on GNSS positioning information. As an example, a value of the region ID may be selected from {1, 2, 3, 4, . . . }, where a larger sub-area ID indicates closer proximity to the edge of the NTN satellite coverage, and a value of M(i) may be configured with a smaller value.

In some embodiments, the network device may directly group EDT-RNTI, or group EDT-RNTI based on characteristics of grouped terminal devices. In an embodiment, when grouping RNTI directly, multiple RNTI may be divided into multiple RNTI sets. In an embodiment, multiple RNTI sets may correspond to multiple terminal device sets.

As an example, when the first RNTI is one in the first RNTI set of multiple RNTI sets, the first message may include an identifier of the first RNTI set. The identifier may facilitate the network device to perform blind decoding using the RNTI within the first RNTI set.

As an example, the network device may first assign a group EDT-RNTI (e.g., based on the same service type) to a group of terminal devices, and EDT-RNTIs of the terminal devices within the group may be determined based on this group EDT-RNTI. For example, EDT-RNTIs is divided into G groups, where G is a positive integer. Each group may have a group identifier, and EDT-RNTI(i) based on the group identifier may have X group members, where i is a positive integer from 1 to G. Identifiers of the X group members may be EDT-RNTI(i)₁, EDT-RNTI(i)₂, EDT-RNTI(i)₃, . . . , EDT-RNTI(i)_{X}, respectively.

In the above embodiment, multiple terminal devices may request access at the same time. If the first terminal device fails to send the first message using EDT-RNTI(i)₁, the first terminal device may send the first message using EDT-RNTI(i)₂ and request access in this order. If the first terminal device successfully sends the first message using EDT-RNTI(i)₂, the base station decodes the message using all indices within EDT-RNTI(i). Since decoding is performed only within the group, the base station can quickly perform blind decoding of the first message.

In some embodiments, the first RNTI may be determined based on one or more of the following parameters: an ID of the first terminal device, a cell RNTI (C-RNTI), and a temporary mobile subscription identifier (TMSI). The network device or the first terminal device may calculate the first RNTI based on these parameters. It should be understood that the first RNTI may also be determined based on other parameters.

As an example, the first RNTI may be determined based on the first terminal device's ID or TMSI. For example, the first terminal device may calculate the first RNTI based on its own ID and carry the first RNTI in the first message.

As an example, the first RNTI may be determined based on the C-RNTI. For example, the first terminal device may retain the C-RNTI for a period of time Tₘₐₓ after transitioning from the RRC connected state to the RRC idle state. That is, if the first terminal device remains in the idle state for longer than Tₘₐₓ, the C-RNTI will not be stored. Within Tₘₐₓ, the first message may carry the C-RNTI MAC CE. Outside of Tₘₐₓ, the first message does not carry the C-RNTI MAC CE. For example, the first terminal device sets a timer Tₘₐₓ. When receiving an RRC release message, the first terminal device starts the timer Tₘₐₓ and retains the C-RNTI. The first message may carry the C-RNTI, and the downlink feedback sent by the network device may use the C-RNTI to calculate the first RNTI, and indicate a contention resolution result via the PDCCH scrambled with the first RNTI.

For example, when Tₘₐₓ expires, the first terminal device discards the stored C-RNTI. When subsequently transitioning from the RRC idle state to the RRC connected state, the first RNTI is configured to send the first message. The first RNTI cannot be calculated using the C-RNTI, and the downlink feedback sent by the network device uses the first RNTI to indicate the contention resolution result.

Referring to FIG. 3, in operation S320, the first terminal device receives a feedback message for a first EDT sent by the network device.

The feedback message for the first EDT is configured to indicate whether the first EDT or the first EDT request is successful. In some embodiments, when the first terminal device requests the first EDT, the first terminal device must wait for the feedback message. In some embodiments, after the first terminal device directly sends data to be transmitted corresponding to the first EDT in the first message, the first terminal device also needs to wait for the feedback message. For example, after the first terminal device sends UL data along with an early data request or an RRC connection resume request, it cannot be assumed that the EDT has been successfully completed. Only after the network device successfully receives the UL data as indicated by the RRC message can the first EDT be considered successful.

As an example, the feedback message for the first EDT is configured to indicate a result of contention resolution.

As an example, the feedback message for the first EDT may be carried in the PDCCH (DCI), and the first terminal device monitors this message.

In some embodiments, the feedback message for the first EDT may be any one or more of the information received by the first terminal device. For example, the feedback message for the first EDT may be any one or more of the following: RRCEarlyDataComplete; RRCConnectionRelease, ContentionResolution, and acknowledgment (ACK) from layer 1 (L1) and/or layer 2 (L2).

In some embodiments, the feedback message for the first EDT is determined based on the type of the first message. For example, when the first message requested by the first EDT is RRCEarlyDataRequest, the feedback message may be RRCEarlyDataComplete. For example, when the first message is RRCConnectionResumeRequest, the feedback message may be RRCConnectionRelease.

As an example, only when the first terminal device receives the RRCEarly DataComplete or RRCCnnectionRelease message will the first EDT or the first EDT request be considered successful.

As an example, ContentionResolution includes Msg4 ContentionResolution. When the first message is message 3, the feedback message for the first message may be Msg4 ContentionResolution. If the first RNTI carried by Msg4 ContentionResolution is the same as the first RNTI reported by the first terminal device in message 3, the first terminal device can consider itself to have successfully sent EDT data.

In some embodiments, after the first EDT is successful, the network device may also terminate the EDT process using an ACK without data. This ACK may be L1/ACK or L2/ACK. For example, in a PUR shared resource pool, the network device may terminate the EDT process by sending a TA command (TAC) without data or an L1/ACK or L2/ACK in an RRC response message.

In some embodiments, the first terminal device may receive a feedback message of the first message based on the first timer. The first timer may also be referred to as a contention resolution timer. For example, the first terminal device starts the first timer after sending the first message, and terminates the first timer after receiving the feedback message of the first message.

For ease of understanding, an exemplary description is given with reference to FIG. 4. FIG. 4 is presented from the perspective of the terminal device and the network device. The terminal device in FIG. 4 may be the first terminal device, and the first RNTI is the EDT-RNTI. Terms already explained above are not repeated here.

Referring to FIG. 4, in operation S410, the terminal device sends an RRC early data request to the network device. This request may be the first message. Compared with operation S210 in FIG. 2, this request includes not only the resume identity ID, establishment cause, and NAS dedicated information but may also include the EDT-RNTI corresponding to the terminal device. Operation S420 is the same as operation S220 in FIG. 2 and are not repeated here. As shown in FIG. 4, after executing operation S410, the terminal device starts a contention resolution timer, and when operation S420 is executed, the timer stops counting.

As shown in FIG. 4, the contention resolution timer facilitates the terminal device in monitoring the feedback messages sent by the network device and promptly performing a fallback. Within the Mac-contentionResolution Timer timeframe, if an EDT-RNTI carried in the Msg4 ContentionResolution message received by the terminal device matches the EDT-RNTI reported in the earlier data request, the terminal device can consider the EDT data transmission successful. Otherwise, the terminal device deems the request failed and re-attempts access according to the previously described rules.

In some embodiments, if the first EDT fails, the first terminal device determines whether to execute a random access procedure. For example, if the first terminal device has not received an indication that the first EDT or the first EDT request is successful, the first terminal device may continue to send the first message to request the first EDT or perform the first EDT. For example, if the first terminal device does not receive an indication that the first EDT or the first EDT request is successful within a set time of the first timer, the first terminal device reverts to the normal random access procedure and performs data transmission according to the normal procedure. In other words, the first terminal device abandons the current early data request or EDT.

In some embodiments, the first resource may be configured for some or all of the terminal devices in the first terminal device set to request EDT. As described above, the first RNTI may be associated with the transmission resources (first resource) for the first message. Taking message 3 as an example, if multiple terminal devices transmit message 3 on the same resource, responses (feedback messages) from multiple terminal devices may be multiplexed into a single msg4 message. In other words, the network device may send a “multiplexed message 4” to multiple terminal devices instead of sending individual messages 4 separately.

As an example, the network device may perform multiplexed transmission of feedback corresponding to multiple terminal devices via a single physical downlink shared channel (PDSCH).

To facilitate understanding, the following illustratively describes the procedure for feedback multiplexing of multiple terminal devices in conjunction with FIG. 5. FIG. 5 schematically illustrates the interaction between two terminal devices and the network device. The two terminal devices are referred to as a terminal device 1 and a terminal device 2.

Referring to FIG. 5, in operation S510, the terminal device 1 and the terminal device 2 each send an RRC early data request and initiate a contention resolution timer. The content of this request is the same as that in operation S410 of FIG. 4 and are not repeated here.

In operation S520, the network device may provide information feedback to both the terminal device 1 and the terminal device 2 via a single feedback message. As shown in FIG. 5, the feedback message sent by the network device includes message 4 for the terminal device 1 and message 4 for the terminal device 2.

As an example, the network device may schedule multiple messages 4 within a single MAC PDU. A multicast message 4 (reusing messages 4 for multiple terminal devices) or multiple messages 4 scheduled with a single DCI may serve as a solution.

In some embodiments, since the number of terminal devices within the NTN system may reach tens of thousands, when multiple terminal devices synchronously send the first messages based on regional grouping/service type, feedback messages for first messages may be a group message. That is, the feedback messages corresponding to multiple terminal devices may be sent via a single group signaling message.

As an example, a group message may be configured to send feedback messages for all terminal devices in a terminal device set that have requested an EDT. The terminal device set may be referred to as a first terminal device set. For example, a feedback message for the first EDT is one of messages in the group message. The group message includes feedback messages for some or all of the terminal devices in the first terminal device set that have requested an EDT, with the some or all of the terminal devices including the first terminal device.

As an example, group information (group message) is established for all terminal devices with EDT-RNTI in message 3. The group message includes feedback messages for all terminal devices that sent EDT-RNTI Msg3. The group message is configured to send to all terminal devices within the group.

As an example, in an NTN cell, a movement speed of the terminal device relative to the satellite may be considered nearly stationary, especially for IoT terminal devices. Therefore, the network device may establish a group for each sub-region. This group may be established based on a temporary mobile group identifier (TMGI), session ID, group RNTI (G-RNTI), semi-persistent scheduling G-RNTI (SPS G-RNTI), configuration information of service data adaptation protocol (SDAP) entity, configuration information of packet data convergence protocol (PDCP) entity, configuration information of radio link control (RLC) entity, and physical layer configuration information.

As an example, to receive a group message, the terminal device may perform the same network access procedure as for unicast and enter the same state as after unicast network access. At the physical layer, receiving multicast (packet transfer mode, PTM) involves only one operation: the terminal device acquires configuration information for blindly detecting multicast broadcast service traffic channels (MTCHs) through RRC signaling. Based on this configuration information, scheduling information for the MTCHs is obtained by blindly detecting PDCCH. Based on the scheduling information for the MTCHs, multicast data is obtained from multicast transmission channel (MTCHs/PDSCH) carried on the PDSCH.

As an example, to receive a multiplexed group message, the terminal device may perform a normal network access procedure. In the RRC connection state, the terminal device may obtain configuration information of a group it belongs to through blind detection of RRC signaling. The configuration information of the group, such as group ID and group TMSI, is stored in the terminal device and the base station and is not released over time unless the group's configuration information is reacquired based on a random re-access. Based on the configuration information of the group, the PDCCH is monitored to obtain scheduling information of the group. Based on the scheduling information of the group, a terminal device with a specific region ID/group ID may receive a group message containing multiple feedback messages.

In some embodiments, the structure design of the group message must consider the correspondence between multiple terminal devices and multiple feedback messages. As an example, the group message may be carried within an MAC service data unit (SDU).

For example, when the first terminal device belongs to the first terminal device set, the group message containing first EDT feedback messages may be carried in a first MAC SDU. Reserved bits in the header of the first MAC SDU may be configured to indicate a service type corresponding to the first terminal device set or an identifier of a sub-region where the first terminal device set is located.

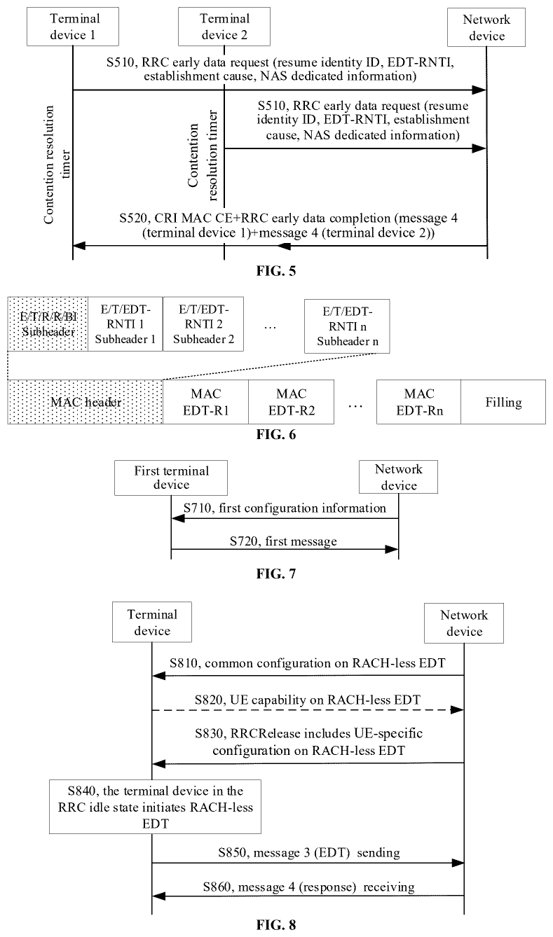

For ease of understanding, the following exemplarily describes a group signaling message using a possible structure of a MAC SDU as an example in conjunction with FIG. 6. The MAC SDU in FIG. 6 may be a first MAC SDU, and MAC EDT-Rn represents a response to the terminal device n. As shown in FIG. 6, the MAC SDU includes a MAC header, responses to n terminal devices, and padding.

Referring to FIG. 6, the MAC header includes a total subheader and n subheaders corresponding to n terminal devices. The n subheaders are subheader 1, subheader 2, . . . , subheader n. The total subheader includes fields E/T/R/R/BI, while the other subheaders include fields E/T/EDT-RNTI n. R is a reserved bit. The meanings of the fields in FIG. 6 are as follows.
E: the extension field is a flag indicating whether an MAC subPDU containing the MAC subheader is the last MAC subPDU in the MAC PDU. If the E field is 1, it is indicated that there is at least one more MAC subPDU following the MAC subPDU; and if the E field is 0, it is indicated that the MAC subPDU is the last MAC subPDU in the MAC PDU.
T: the type field is a flag indicating whether the MAC subheader contains an EDT identifier or a backoff indicator (BI). If the T field is 0, it is indicated that there is no BI in the subheader and no overload; and if the T field is 1, it is indicated that not all terminal devices are satisfied in the overall subheader, and the corresponding terminal device does not have an EDT-RNTI in each subsequent subheader.
R: the reserved field, which is a reserved resource, may be set as an NTN region ID field or a service type identifier.
BI: the backoff field indicates an overload status in the cell, with a size of 4 bits, capable of representing 16 possible indices.
EDT-RNTI: the EDT field is configured to identify an EDT-RNTI corresponding to each terminal device. The EDT-RNTI field has a size of 16 bits.

In some embodiments, the first message may be transmitted based on the first TA value. That is, the first terminal device performs the uplink transmission of the first message based on the first TA value. As an example, the first TA value has not been adjusted by any NW. The first TA value should be a valid timing alignment value to facilitate uplink transmission.

As an example, to support direct transmission of message 3 in the deployment of low earth orbit (LEO) satellites, the first terminal device needs to estimate whether the TA value is sufficiently accurate for the first message 3 or the first PUSCH transmission.

In some embodiments, the current TA may be pre-compensated by the first TA value to improve accuracy. For example, the first terminal device may transmit the first message based on the pre-compensated TA. Therefore, the first TA value may also be referred to as a compensation value of TA.

As an example, the current TA may be a TA value of the first terminal device before pre-compensation. For example, the current TA may be determined by the first terminal device based on the currently stored TA. When multiple TA values are stored, the first terminal device may select the most recently stored TA as the current TA, or select the maximum, minimum, or average value of the stored TA as the current TA.

In some embodiments, pre-compensation is performed by the first TA value based on one or more of the following parameters: a duration of the first terminal device being in the idle state; a TA value stored by the first terminal device during the previous TA adjustment; a maximum TA pre-compensation value when the first terminal device is previously in the connected state; and path loss and Doppler frequency offset when the first terminal device receives configuration information for multiple common PURs. A parameter for pre-compensating the first TA value determined by the above parameters may also be referred to as a compensation value for the first TA value.

As an example, the first TA value may be determined based on the duration of the idle state. The first terminal device may determine the duration it has been in the RRC idle state, i.e., an idle state duration. For example, this duration may be configured to determine a calculation factor for the current TA. The first terminal device may determine the first TA value based on the current TA and the calculation factor.

As an example, the first TA value may be determined based on the TA value stored during the previous TA adjustment. The TA value stored during the previous TA adjustment refers to the TA value stored by the first terminal device during its most recent TA adjustment (e.g., in the RRC connected state). For example, the first terminal device may configure corresponding compensation parameters to compensate for this TA value to determine the first TA value.

As an example, the first TA value may be determined based on the duration of the idle state and the TA value stored during the previous TA adjustment. For example, if the duration of the first terminal device in the idle state is T_{delay} and the TA value stored during the previous TA adjustment is T_{TA}, the first TA value or the compensated value of the first TA value may be T_{delay}×T_{TA}. In an NTN system, when T_{delay}×T_{TA} is directly used as the first TA value, this parameter may be smaller than the maximum TA value estimated based on the maximum Doppler frequency offset within the NTN cell.

As an example, the first TA value may be determined based on the maximum TA pre-compensation value from the previous connection state of the first terminal device. That is, when performing TA pre-compensation, the first terminal device may use the maximum TA pre-compensation value from the previous connection as the initial compensation value.

As an example, the first TA value may be determined based on the path loss and Doppler frequency offset when receiving configuration information for multiple common PURs. For example, configuration information for multiple common PURs is configuration parameters related to common PURs that are sent by the network device. For example, the first terminal device may trigger a PUR request. When the network device sends PUR configuration to the first terminal device, the first terminal device may estimate the magnitudes of the path loss and Doppler frequency offset based on the signaling sent by the network device, thereby adjusting the TA value.

The above description, in conjunction with FIGS. 3 to 6, introduces the method for determining the first resource based on contention resolution. Based on this method, the network device does not need to configure PUR for each terminal device, and may be applicable to EDT scenarios where there are a large number of terminal devices within NTN cells or the like.

### Embodiment 2

In this embodiment, the first terminal device selects the first resource from multiple common PURs using a contention-free method. In other words, the first resource is one of the multiple common PURs (CFS PUR) selected using the contention-free method. As mentioned earlier, when the first resource is determined using the contention-based method, multiple terminal devices may select the same resource to send EDT or EDT requests. In such a scenario, this may result in some PURs in the multiple common PURs needing to send a large number of messages, while others have no messages to send.

To address this issue, the present disclosure further provides a method for wireless communication. In this method, the network device configures the first resource for the first terminal device to send an EDT or an EDT request. Through this method, multiple terminal devices may send EDT requests on the configured resources, and the network device may determine which terminal device the received EDT request originated from, thereby avoiding resource waste.

For ease of understanding, the method for wireless communication is described below in conjunction with FIG. 7. FIG. 7 is also presented from the perspective of interaction between the first terminal device and the network device. For brevity, terms already explained in FIG. 3 are not repeated here.

Referring to FIG. 7, in operation S710, the first terminal device receives the first configuration information sent by the network device.

The first configuration information may be carried in a SIB or in RRC dedicated signaling. That is, the network device may provide corresponding configuration information to each terminal device based on dedicated RRC signaling or through broadcast signaling.

As an example, the RRC dedicated signaling may include an RRC connection release message. For example, the first configuration information may be carried by an RRC connection release message sent by the network device before the first terminal device enters the idle state, which facilitates receiving of the first configuration information by the first terminal device. For another example, the configuration of multiple common PURs may be sent to the terminal device via an RRCConnectionRelease message.

The first configuration information is configured by the first terminal device to determine the first resource. As mentioned earlier, the first resource is configured to send the first message, which is configured for requesting the first EDT or performing the first EDT. The first resource is one of multiple common PURs.

As an example, when the network device releases the first terminal device to the RRC idle state, the network device configures the first resource for the first terminal device based on multiple common PUR configuration requests, subscription information and/or local policies.

It should be noted that in FIG. 7, multiple common PURs are configured for data transmission in NTN. That is, this embodiment is configured for wireless communication in an NTN system. When terminal devices in an NTN cell support NTN RACH-free EDT, multiple common PURs may be used.

In some embodiments, the first configuration information may be configured to indicate one or more of the following: a first RNTI corresponding to the first terminal device; a resource for a demodulation reference signal (DMRS) corresponding to the first terminal device; an allocation method for multiple common PURs; and resource indices within multiple common PURs. As mentioned earlier, the first RNTI may be an EDT-RNTI.

As an example, the DMRS corresponding to the first terminal device may be a DMRS dedicated to the first terminal device.

As an example, the network device may pre-configure dedicated RNTI and/or DMRS resources for each terminal device. In a specific common PUR, multiple terminal devices may simultaneously send messages 3. The network device may decode one or more messages 3 from different terminal devices. The network device may distinguish terminal devices using EDT-RNTI (for data scrambling and CRC scrambling) and/or dedicated DMRS embedded in message 3. Accordingly, the network device may use a terminal device-specific EDT-RNTI to send message 4.

As an example, the network device may provide an allocation scheme for multiple common PURs to facilitate terminal devices in determining the corresponding uplink resources.

As an example, the network device may provide resource indices in multiple common PURs for each terminal device, enabling the terminal devices to determine corresponding uplink resources based on indices in the corresponding configuration information. For example, the network device may configure some different resource information for different terminal devices, while other resource information may be the same for all terminal devices. In this scenario, the network device may provide multiple sets of public resource information via SIB, and then use dedicated signaling to indicate a resource set index specific to a terminal device.

Referring to FIG. 7, in operation S720, the first terminal device sends a first message on the first resource. Operation S720 is the same as operation S610 in FIG. 6 except that the first resource in FIG. 7 is configured by the network device for the first terminal device and will not be used by other terminal devices, so the first terminal device does not need to wait for a feedback message.

In some embodiments, the first message may include a first RNTI and/or DMRS to facilitate identification by the network device. The DMRS may be a DMRS dedicated to the first terminal device.

In some embodiments, the first configuration information may be configured based on the first terminal device's configuration request. This configuration request may also be referred to as a PUR configuration request. For example, the configuration request sent by the first terminal device to the network device may be configured to request the first configuration information. In other words, after configuring multiple common PURs, the network device does not configure corresponding uplink resources for all terminal devices in the cell.

In some embodiments, the configuration request may include one or more of the following information: the first terminal device's capability information, a service type of the first terminal device, and whether the first terminal device enables EDT-related configuration.

As an example, the first terminal device may directly send a configuration request for uplink resources to make an explicit request. For example, the first terminal device may directly inform the network device that it will send the first message and request the network device to configure the first resource.

As an example, the first terminal device may request the network device to configure uplink resources in an implicit manner. For example, the first terminal device may enable or disable configuration of RACH-free EDT. When the configuration request includes information about enabling or disabling EDT, the network device may determine, based on whether EDT is enabled, whether to configure the uplink resource and send the first configuration information.

For example, the network device may determine whether to send the first configuration information based on whether the first terminal device enables EDT-related configuration. When the first terminal device enables RACH-free EDT configuration, the network device may configure the first resource for the first terminal device and send the first configuration information. When the first terminal device disables the RACH-free EDT configuration, the network device does not configure uplink resources for the first terminal device and therefore does not send the first configuration information.

For example, the first terminal device may use its own capability information to support the functionality of enabling or disabling the EDT configuration. If the capability information of the first terminal device indicates that the first terminal device does not have the capability to enable the EDT configuration, the network device does not configure uplink resources for the first terminal device and therefore does not send the first configuration information.

In some embodiments, the configuration request sent by the first terminal device may further include a first indication. The first indication is configured to indicate whether EDT-related transmission enables ACK or negative acknowledgment (NACK) feedback. The first indication is, for example, “RRC ACK.”

As an example, the EDT-related transmission may include each interaction between the terminal device and the network device during the EDT transmission process.

As an example, the EDT-related transmission may include all subsequent PUR events following the transmission of the first indication.

As an example, in an NTN system, when the first terminal device transmits a RACH-free EDT in a CFS PUR scenario, the first terminal device may send an indication “RRC ACK” in the PUR configuration request. This indication may be applied to all subsequent PUR events configured based on PUR Configuration. For example, an ACK/NACK may be sent in each subsequent interaction to indicate whether the information is received.

In some embodiments, the network device may assign a common PUR to each terminal device that sends a configuration request. For example, when an NTN cell where the first terminal device is located includes multiple terminal devices requesting EDT, multiple common PURs are assigned to multiple terminal devices. For example, the first configuration information may be configured to indicate multiple resources corresponding to the multiple terminal devices. That is, the first configuration information may simultaneously indicate multiple uplink resources for the multiple terminal devices to perform the first EDT or request the first EDT. For example, when multiple common PURs are assigned to terminal devices requesting resources based on the base station, the assignment may be made according to service types of the terminal devices.

In some embodiments, the network device may allocate resources based on the resources requested or required by multiple terminal devices.

As an example, the resources requested by multiple terminal devices may be the same, or the network device may allocate resources of the same size to each terminal device. For example, when each terminal device requests the same resources, multiple common PURs may be evenly divided. In this scenario, a size of a transport block (TB) corresponding to data transmitted in each EDT may be set to be the same. If the size of the transport block in a particular EDT is insufficient, zero-padding may be performed to achieve the same TB size.

As an example, multiple terminal devices may have different resource demand sizes. For example, the network device may allocate resources based on sizes of resources requested by multiple terminal devices. For instance, a number of resources available for allocation in multiple common PURs is R (where R is a positive integer), and there are K (where K≤M) terminal devices that simultaneously request and are granted access to use EDT PURs. A number of resources required by each of the K terminal devices may be represented as Sᵢ. The network device may sort the sizes of the resources requested simultaneously, such as S₀≥S₁≥ . . . ≥S_{K-1}, where i=0, 1, . . . , K−1. Furthermore, the network device may adjust and allocate resources based on this sorting.

As an example, resources requested by a terminal device i is denoted by Sᵢ, and resources allocated by the network device to the terminal device i is denoted by Rsi. If Rsi≥Sᵢ, the network device allocates resources of Sᵢ to the terminal device i, and the remaining resources become R-Rsi, and so on.

In some embodiments, if resources allocated by the network device to the first terminal device are greater than or equal to resources requested by the first terminal device, the first terminal device may directly send the first message or perform the first EDT. If the resources allocated by the network device to the first terminal device are less than the resources requested by the first terminal device, the first terminal device cannot send the first message or perform the first EDT.

As an example, in response to the first resource being greater than or equal to a resource requested by the first terminal device, the first EDT succeeds; or in response to the first resource being less than a resource requested by the first terminal device, the first EDT fails.

As an example, the multiple common PUR resources reserved by the network device may be allocated sequentially based on the sizes of the resources requested by the terminal devices. If the terminal device j requests resources of Sⱼ and the available resources Rsj<Sⱼ, access for message 3 fails. From the network device's perspective, each terminal device requiring EDT transmission has a corresponding allocation coefficient to indicate successful allocation or failure to allocate.

In some embodiments, upon failure of the first EDT, the first terminal device may perform a first message retransmission or a random access procedure. As an example, the first terminal device may start a second timer. Upon expiry of the second timer, the first terminal device performs the retransmission of the first message. As such, the second timer is used by the first terminal device to time the retransmission of the first message and may also be referred to as a waiting timer.

As an example, upon failure of the first EDT, the first terminal device may enter a buffer for waiting and start the second timer T. The duration of the second timer may be configured by the network device, and stored in the first terminal device and/or the network device. During a period when the second timer is running, the first terminal device does not need to resend. Upon expiry of the second timer, the first terminal device retransmits the first message.

In some embodiments, when a number of retransmissions of the first message reaches a second threshold, the first terminal device performs a random access procedure. That is, the first terminal device does not continuously send the first message. For example, the first terminal device or network device may set the number of retransmissions, i.e., the second threshold. When the number of retransmissions of the first message reaches or exceeds the second threshold, the first terminal device reverts to the normal random access procedure and performs normal data transmission.

In some embodiments, a terminal device in the RRC idle state finds it difficult to directly resume using its specific PUR configuration after cell reselection to another cell. In such case, the terminal device must re-enter the RRC connected state to request a corresponding PUR configuration after reselection to a new service cell.

The above introduces a method for determining the first resource in a contention-free manner in conjunction with FIG. 7. For ease of understanding, an exemplary description is given with reference to FIG. 8. FIG. 8 is also presented from the perspective of the terminal device and the network device. Dashed lines indicate that the process is not mandatory.

Referring to FIG. 8, in operation S810, the terminal device may receive common configuration on RACH-less EDT sent by the network device. The network device may be an NTN network. The NTN network sends the configuration information of multiple common PURs on the RACH-less EDT to the terminal device, or the terminal device may request the network device to send the configuration information of multiple common PURs via a specific RRC message PURConfigurationRequest.

In operation S820, the terminal device may report capability information about the RACH-less EDT (UE capability on RACH-less EDT). The reported capability of the terminal device may also include a service type.

In operation S830, the network device may indicate terminal device-specific configuration on the RACH-less EDT to the terminal device via an RRCRelease message (RRCRelease including UE-specific configuration on RACH-less EDT). The terminal device-specific configuration may refer to resource configuration information specific to the terminal device.

After executing operation S830, the terminal device's RRC state transitions from the RRC connected state to the RRC idle state. When the terminal device is released to the RRC idle state, the UE is dedicatedly configured with a PUR. For example, the PUR is configured in RRCConnectionRelease.

In operation S840, the terminal device is in the RRC idle state and initiates RACH-less EDT. The terminal device has transitioned from the RRC connected state to the RRC idle state.

In operation S850, the terminal device sends message 3, which includes higher-layer data such as RRC early data request/RRC connection resume request. Message 3 may carry the terminal device-specific EDT-RNTI and/or DMRS, and may be transmitted on the acquired PUR.

In operation S860, the network device sends a message 4 for response, and the terminal device receives the message 4. When resource contention occurs within a group, the message 4 may include a contention resolution message and may contain higher-layer data, etc.

The above, in conjunction with FIGS. 7 and 8, introduces a method for multiple terminal devices requesting EDT to determine uplink resources in a contention-free manner. Through this method, the issue of resource utilization imbalance that may arise from multiple common PURs may be avoided.

### Embodiment 3

In this embodiment, the first terminal device may determine the first resource in a manner of a combination of Embodiment 1 and Embodiment 2. For example, multiple common PURs corresponding to a terminal device set in which the first terminal device is included are determined in a contention-free manner. Within the terminal device set, the first terminal device determines the first resource from the multiple common PURs in a contention-based manner.

In some embodiments, the first RNTI is specific to the first terminal device. For the multiple common PURs corresponding to the terminal device set in which the first terminal device is included, the network device needs to perform blind detection on each common PUR to attempt all possible EDT-RNTIs, and then send message 4 to notify the first terminal device whether decoding is successful.

As an example, the first terminal device determines a first resource pool where the first resource is located based on the first configuration information. Within the first resource pool, the first terminal device selects the first resource to send the first message and monitors the feedback message sent by the network device. In other words, the first configuration information is configured to indicate the first resource pool, and the first terminal device determines the first resource within the first resource pool in a contention-based manner.

In some embodiments, multiple common PURs may be divided into multiple resource pools. Among multiple resource pools, a resource pool corresponding to the terminal device is determined based on the first configuration information in a contention-free manner. That is to say, the network device may configure resources in multiple resource pools based on multiple division methods. Within each resource pool, multiple terminal devices determine the corresponding uplink resources separately in a contention-based manner.

As an example, the resource pool in which the first resource is located may be determined based on one or more of the following information: signal quality of a configuration request sent by the first terminal device; a coverage enhancement (CE) level of a location of the first terminal device; a service time of the first terminal device; and a service type of the first terminal device. The first terminal device may determine the resource pool in which the first terminal device is located based on corresponding parameters.

As an example, multiple common PURs may be divided into multiple resource pools based on one or more of the following information: signal quality of configuration requests sent by multiple terminal devices; CE levels of locations of multiple terminal devices; service times of multiple terminal devices; and service types of multiple terminal devices. The signal quality of the configuration requests sent by multiple terminal devices may also be referred to as energy detection results.

As an example, multiple resource pools may be divided according to the CE level. Multiple terminal devices may be configured to determine the corresponding resource pools based on the CE levels. That is, the first terminal device may select the first resource based on a current CE level. The current CE level may be a CE level of a current location of the first terminal device.

For example, for terminal devices with bandwidth reduced low complexity (BL)/CE, there are a total of four PRACH CE levels: 0, 1, 2, and 3. CE levels 0 and 1 correspond to CEModeA, and CE levels 2 and 3 correspond to CEModeB.

As an example, multiple resource pools may be divided based on the signal quality of the configuration request. The signal quality is, for example, a reference signal received power (RSRP). When the network device receives a request signal from the first terminal device with an RSRP greater than a first threshold, the first terminal device may use the configured multiple common PURs. That is, when the signal quality of the configuration request sent by the first terminal device is greater than the first threshold, the first terminal device determines the first resource in multiple resource pools.

In the above example, multiple resource pools may be divided based on multiple different signal quality ranges. When the signal quality of the configuration request sent by the first terminal device is within a first value range, the first terminal device determines the first resource in the resource pool corresponding to the first value range.

As an example, multiple resource pools may be determined based on CE levels and signal quality. For IoT, the transmission of message 3 with different CE levels may correspond to different modulation and coding schemes (MCS), repetition counts, etc., and different CE levels correspond to different RSRP detection thresholds. For example, CE levels from 0 to 3 represent gradually deteriorating channel quality. CE level 0 indicates a scenario of the best channel quality; CE level 3 indicates a scenario of the worst channel quality. Thresholds for shared resource pools are set based on RSRP values for different CE levels, meaning that the four CE levels may divide the entire resource pool of common PUR into four parts, i.e., four resource pools. Each part may correspond to a separate RSRP threshold: RSRP1, RSRP2, RSRP3, and RSRP4.

As an example, a resource pool where the first resource is located may be determined based on the CE level and carrier configuration. The first terminal device may first determine the CE level based on the RSRP of the service cell. For the selected CE level, if the resource pool of the corresponding message 3 is configured on multiple carriers, the first terminal device may perform carrier selection. For example, the first terminal device may select a carrier based on a probability factor.

As an example, multiple resource pools may be determined based on results of energy detection and service time. For example, multiple common PURs are first divided into two blocks based on the result of energy detection. Specifically, a basic RSRP threshold is set for the resource pool, and the multiple common PURs are divided into two resource block subsets: subset A and subset B. In response to an RSRP of a request signal received by the network device from the terminal device being greater than or equal to this threshold, and/or the service time is outside T-service, the terminal device can use multiple common PURs and is assigned to a specific resource block subset A. In response to the RSRP of the request signal received by the network device from the terminal device being less than this threshold, and/or the service time is within T-service, the terminal device can use multiple common PURs and is assigned to a specific resource block subset B.

In the above example, the resource subsets A and B for sharing may be pre-configured, and a starting slot index of the resource subset A is calculated starting from an initial position in the entire resource pool. A starting slot index of the resource subset B follows immediately after the last slot index of the resource subset A. In other words, a time-domain position of the resource subset A precedes a time-domain position of the resource subset B.

In the above example, the starting time slot index of the resource subset A may be calculated from a specified position of the entire resource pool.

As an example, the resource pool where the first resource is located may be determined based on the service time of the first terminal device. For example, the first terminal device corresponds to the first NTN cell, multiple resource pools include the first resource pool and the second resource pool, and a time-domain position of the first resource pool is earlier than a time-domain position of the second resource pool. When the service time of the first terminal device is outside the service time (T-service) of the first NTN cell, the first terminal device determines the first resource on the first resource pool so that the first terminal device can send the first message in a timely manner. When the service time of the first terminal device is within the service time of the first NTN cell, the first terminal device determines the first resource on the second resource pool. When the service time is within T-service, the service of the first terminal device is not urgent, and multiple common PURs may give priority to other terminal devices whose service time is outside T-service.

As an example, when the NTN cell where the first terminal device is located supports L types of service types, the multiple resource pools are L resource pools. The size of each resource pool in the L resource pools is determined according to the service priority. For example, all service types supported in the NTN cell are defined. It is assumed that L classes are supported based on the quality of service class identifier (QCI). When there are M×N physical resource blocks (PRBs) on each slot or resource, each service type may be allocated (M×N)/L resources. That is, on average, each service type is allocated a maximum of (M×N)/L resources. A fairness factor Qⱼ is provided for each service type, where j=0, 1, . . . , L−1. The system may allocate a fairness factor to each service type based on service priority. If the maximum resources allocated to all services are each (M×N)/L, then the resources allocated to service type j are: Qⱼ×(M×N)/L, where Qⱼ≤1.

In embodiment 3, the terminal device may first determine the resource pool of the first resource in the contention-free manner, and then select the first resource from the resource pool in the contention-based method to send the first message. Through this method, the resource conflict problem caused by too many terminal devices in the NTN system can be effectively solved, and the problem of resource utilization imbalance can be minimized.

The above describes in detail the method embodiments of the present disclosure in conjunction with FIGS. 1 to 8. The following describes in detail device embodiments of the present disclosure in conjunction with FIGS. 9 to 11. It should be understood that the description of the device embodiments corresponds to the description of the method embodiments, so the parts that are not described in detail may be referred to in the previous method embodiments.

FIG. 9 is a schematic block diagram of a apparatus for wireless communication according to embodiments of the present disclosure. The apparatus 900 may be any of the first terminal devices described above. The apparatus 900 shown in FIG. 9 includes a receiving unit 910 and a sending unit 920.

The receiving unit 910 may be configured to receive first configuration information configured for the first terminal device to determine a first resource.

The sending unit 920 may be configured to transmit a first message on the first resource. The first message is configured to request a first EDT. The first resource is one of a plurality of common PURs configured for data transmission in NTN.

In an embodiment, the first configuration information is carried in a SIB or RRC dedicated signaling.

In an embodiment, the first configuration information is configured to indicate one or more of the following: a first RNTI corresponding to the first terminal device; a resource for a DMRS corresponding to the first terminal device; an allocation scheme of the plurality of common PURs; and a resource index in the plurality of common PURs.

In an embodiment, the first message includes at least one of the first RNTI and/or the DMRS.

In an embodiment, the sending unit 920 is further configured to send a configuration request to a network device, where the configuration request is configured to request the network device to send the first configuration information.

In an embodiment, the configuration request includes one or more of the following information: capability information of the first terminal device; a service type of the first terminal device; and whether the first terminal device enables EDT-related configuration.

In an embodiment, the configuration request further includes a first indication configured to indicate that EDT-related transmission enables ACK/NACK feedback.

In an embodiment, an NTN cell where the first terminal device is located includes a plurality of terminal devices requesting EDT. The plurality of common PURs are allocated to the plurality of terminal devices, and the first configuration information is configured to indicate a plurality of resources respectively corresponding to the plurality of terminal devices.

In an embodiment, in response to the first resource being greater than or equal to a resource requested by the first terminal device, the first EDT is successful; or in response to the first resource being less than a resource requested by the first terminal device, the first EDT is unsuccessful.

In an embodiment, the apparatus 900 further includes: a first processing unit, configured to start a second timer in response to the first EDT being unsuccessful; and a second processing unit, configured to perform retransmission of the first message or a random access procedure upon expiry of the second timer.

In an embodiment, the plurality of common PURs are divided into a plurality of resource pools, the first configuration information is configured to indicate a first resource pool where the first resource is located, and the apparatus 900 further includes a determining unit configured to determine the first resource in the first resource pool in a contention-based manner.

In an embodiment, the first terminal device is one of a plurality of terminal devices, and the plurality of resource pools are determined according to one or more of the following information: signal quality of configuration requests sent by the plurality of terminal devices; coverage enhancement levels at locations of the plurality of terminal devices; service times of the plurality of terminal devices; and service types of the plurality of terminal devices.

In an embodiment, the determining unit is further configured to determine the first resource in the plurality of resource pools in response to a signal quality of a configuration request sent by the first terminal device being greater than a first threshold.

In an embodiment, the first terminal device corresponds to a first NTN cell, the plurality of resource pools include a first resource pool and a second resource pool, a time-domain position of the first resource pool is earlier than a time-domain position of the second resource pool, and the determining unit is further configured to: determine the first resource in the first resource pool in response to a service time of the first terminal device being outside a service time of the first NTN cell; and determine the first resource in the second resource pool in response to the service time of the first terminal device being within a service time of the first NTN cell.

In an embodiment, an NTN cell where the first terminal device is located supports L service types, the plurality of resource pools are L resource pools, and a size of each of the L resource pools is determined according to service priority.

In an embodiment, the receiving unit 910 and the sending unit 920 in the apparatus 900 may both be a transceiver 1130, and the apparatus 900 may further include a processor 1110 and a memory 1120, as shown in FIG. 11.

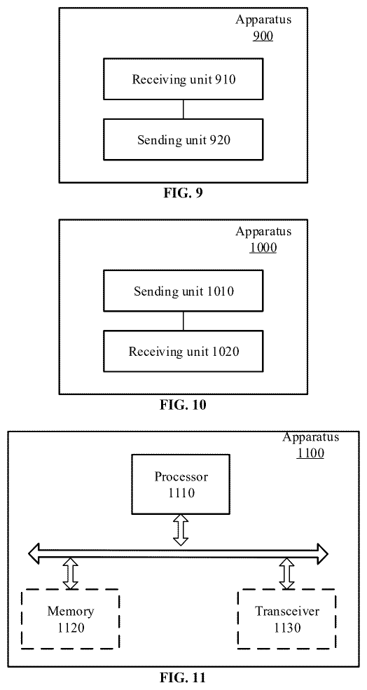

FIG. 10 is a schematic block diagram of another apparatus for wireless communication according to embodiments of the present disclosure. The apparatus 1000 may be any of the network devices described above. The apparatus 1000 shown in FIG. 10 includes a sending unit 1010 and a receiving unit 1020.

The sending unit 1010 may be configured to send first configuration information configured for a first terminal device to determine a first resource,

The receiving unit 1020 may be configured to receive a first message on the first resource, where the first message is sent by the first terminal device and configured to request first EDT. The first resource is one of a plurality of common PURs, and the plurality of common PURs are configured for data transmission in an NTN.

In an embodiment, the first configuration information is carried in a SIB or an RRC dedicated signaling.

In an embodiment, the first configuration information is configured to indicate one or more of the following: a first RNTI corresponding to the first terminal device; a resource for a DMRS corresponding to the first terminal device; an allocation scheme of the plurality of common PURs; and a resource index in the plurality of common PURs.

In an embodiment, the first message includes at least one of the first RNTI and the DMRS.

In an embodiment, the receiving unit 1020 is further configured to receive a configuration request sent by the first terminal device, where the configuration request is configured to request the network device to send the first configuration information.

In an embodiment, the configuration request includes one or more of the following information: capability information of the first terminal device; a service type of the first terminal device; and whether the first terminal device enables EDT-related configuration.

In an embodiment, the configuration request further includes a first indication configured to indicate that EDT-related transmission enables ACK/NACK feedback.

In an embodiment, an NTN cell where the first terminal device is located includes a plurality of terminal devices requesting EDT, the plurality of common PURs are allocated to the plurality of terminal devices, and the first configuration information is configured to indicate a plurality of resources respectively corresponding to the plurality of terminal devices.

In an embodiment, in response to the first resource being greater than or equal to a resource requested by the first terminal device, the first EDT is successful; or in response to the first resource being less than a resource requested by the first terminal device, the first EDT is unsuccessful.

In an embodiment, the receiving unit 1020 is further configured to receive retransmission of the first message or a random access procedure in response to the first EDT being unsuccessful.

In an embodiment, the plurality of common PURs are divided into a plurality of resource pools, the first configuration information is configured to indicate a first resource pool where the first resource is located, and the first resource is determined by the first terminal device in the first resource pool in a contention-based manner.

In an embodiment, the first terminal device is one of a plurality of terminal devices, and the plurality of resource pools are determined according to one or more of the following information: signal quality of configuration requests sent by the plurality of terminal devices; coverage enhancement levels at locations of the plurality of terminal devices; service times of the plurality of terminal devices; and service types of the plurality of terminal devices.

In an embodiment, the sending unit 1010 is further configured to send the first configuration information to the first terminal device in response to a signal quality of a configuration request sent by the first terminal device being greater than a first threshold.

In an embodiment, the first terminal device corresponds to a first NTN cell, the plurality of resource pools include a first resource pool and a second resource pool, and a time-domain position of the first resource pool is earlier than a time-domain position of the second resource pool. The first resource is in the first resource pool in response to a service time of the first terminal device being outside a service time of the first NTN cell, or the first resource is in the second resource pool in response to the service time of the first terminal device being within the service time of the first NTN cell.

In an embodiment, an NTN cell where the first terminal device is located supports L service types, the plurality of resource pools are L resource pools, and a size of each of the L resource pools is determined according to service priority.

In an embodiment, the sending unit 1010 and the receiving unit 1020 in the apparatus 1000 may be each a transceiver 1130, and the apparatus 1000 may further include a processor 1110 and a memory 1120, as shown in FIG. 11.

FIG. 11 is a schematic structure diagram of a communication apparatus of embodiments of the present disclosure. The dotted line in FIG. 11 indicates that the unit or module is optional. The apparatus 1100 may be configured to implement the methods described in the preceding method embodiments. The apparatus 1100 may be a chip, terminal device or network device.

The apparatus 1100 may include one or more processors 1110. The processor 1110 may support the apparatus 1100 in implementing the methods described in the preceding method embodiments. The processor 1110 may be a general purpose processor or a dedicated processor. For example, the processor may be a central processing unit (CPU). Alternatively, the processor may be another general purpose processor, a digital signal processor (DSP), an application specific integrated circuit (ASIC), a field programmable gate array (FPGA) or another programmable logic device, a discrete gate or transistor logic device, or a discrete hardware component, or the like. The general-purpose processor may be a microprocessor or any customary processor or the like.

The apparatus 1100 may further include one or more memories 1120. The memory 1120 has stored thereon a program that is executable by the processor 1110 to cause the processor 1110 to perform the method described in the preceding method embodiments. The memory 1120 may be separate from the processor 1110 or integrated within the processor 1110.

The apparatus 1100 may further include a transceiver 1130. The processor 1110 may communicate with another device or a chip by the transceiver 1130. For example, the processor 1110 may transmit data to, or receive data from, another device or a chip by the transceiver 1130.

Some embodiments of the present disclosure further provide a computer-readable storage medium configured to store a program. The computer-readable storage medium may be applied to a terminal device or a network device according to the embodiments of the present disclosure, and the program causes a computer to perform the method performed by the terminal device or the network device according to the respective embodiments of the present disclosure. The computer-readable storage medium may be any usable medium that is computer-readable or a data storage device such as a server or a data center that includes one or more usable media integrated. The usable medium may be a magnetic medium (e.g., a floppy disk, a hard disk and a tape), an optical medium (e.g., a digital video disc (DVD)), a semiconductor medium (e.g., a solid state disk (SSD)), or the like.

Some embodiments of the present disclosure further provide a computer program product. The computer program product includes a program. The computer program product may be applied to a terminal device or a network device according to the embodiments of the present disclosure, and the program causes a computer to perform the method performed by the terminal device or the network device according to the respective embodiments of the present disclosure.

In the embodiments described above, the technical solutions may be totally or partially practiced by software, hardware, firmware or any combination thereof. During practice by software, the technical solutions may be totally or partially implemented in the form of a computer program product. The computer program product includes one or more computer instructions. Loading and executing the computer instructions on a computer produces, in whole or in part, a process or function in accordance with the embodiments of the present disclosure. The computer may be a general purpose computer, a special purpose computer, a computer network, or other programmable device. The computer instructions may be stored in a computer-readable storage medium or transmitted from one computer-readable storage medium to another computer-readable storage medium. For example, the computer instructions may be transmitted from a web site, computer, server, or data center to another website site, computer, server or data center via a wired means (e.g., coaxial cable, fiber optic and digital subscriber line (DSL)) or a wireless means (e.g., infrared, wireless and microwave).

Some embodiments of the present disclosure further provide a computer program. The computer program may be applied to a terminal device or a network device according to the embodiments of the present disclosure, and the computer program causes a computer to perform the method performed by the terminal device or the network device according to the respective embodiments of the present disclosure.

It should be understood that the terms “system” and “network” in the specification are generally exchanged. Further, the terms used herein are for the purpose of describing particular embodiments only and are not intended to limit the present disclosure. The terms such as “first,” “second,” “third,” “fourth,” and the like in the specifications, claims and the accompanying drawings of the present disclosure are intended to distinguishing different objects but are not intended to define a specific sequence. In addition, terms “comprise,” “include,” and variations thereof are intended to define a non-exclusive meaning.

In the embodiments of the present disclosure, “an indication” mentioned in the specification may be a direct indication, an indirect indication, or an association. By way of example, A indicates B, which can mean that A directly indicates B, e.g., B can be obtained by A; can also indicate that A indicates B indirectly, for example A indicates C, and B can be obtained by C; it can also be shown that there is an association between A and B.

In the embodiments of the present disclosure, the term “correspond” may mean that there is a direct correspondence or an indirect correspondence between the two, that there is a correlation between the two, or that there is a relationship between indicating and being indicated, configuring and being configured, or the like.

In embodiments of the present disclosure, “predefined” or “pre-configured” may be implemented by pre-storing a corresponding code, table, or other means that may be configured to indicate relevant information in a device (e.g., including a terminal device and a network device), and the present disclosure does not limit the specific implementation thereof. For example, the term “predefined” may refer to “defined in the protocol.”

In the embodiments of the present disclosure, determining B from A does not mean determining B from A alone, and B may also be determined from A and/or other information.

In the embodiments of the present disclosure, the term “and/or” is merely an association relationship for describing associated objects, which represents that there may exist three types of relationships, for example, A and/or B may represent three situations: only A exists, both A and B exist, and only B exists. In addition, the forward-slash symbol “/” generally represents an “or” relationship between associated objects before and after the symbol.

In various embodiments of the present disclosure, the sequence numbers of the above various processes or steps do not denote a preferred sequence of performing the processes or steps; and the sequence of performing the processes and steps should be determined according to the functions and internal logics thereof, which shall not cause any limitation to the implementation process of the embodiments of the present disclosure.

In the several embodiments provided in the present disclosure, it should be understood that the disclosed system, apparatus and method may be practiced in other manners. The above described device embodiments are merely illustrative. For example, the unit division is merely logical function division and may be other divisions in actual practice. For example, multiple units or components may be combined or integrated into another device, or some features can be ignored or not performed. In addition, the displayed or discussed mutual couplings or direct couplings or communication connections may be implemented through some interfaces. The indirect couplings or communication connections between the devices or units may be implemented in electronic, mechanical or other forms.

The units which are described as separate components may be physically separated or may be not physically separated, and the components which are illustrated as units may be or may not be physical units, that is, the components may be located in the same location or may be distributed into a plurality of network units. Some or all of the units may be selected according to actual needs to achieve the objectives of the solutions of the embodiments.

In addition, functional units in the embodiments of the present disclosure may be integrated into one processing unit, or each of the units may exist along physically, or two or more units may be integrated into one unit.

The above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. A method for wireless communication, comprising:
receiving, by a first terminal device in a non-terrestrial network (NTN), first information;
determining, by the first terminal device, a first resource based on the first information, wherein the first resource is one of a plurality of common preconfigured uplink resources (PURs), and the plurality of common PURs are configured for data transmission in the NTN; and
sending, by the first terminal device, first early data transmission (EDT) on the first resource.

2. The method according to claim 1, wherein the first information is carried in a system information block (SIB) or a radio resource control (RRC) dedicated signaling.

3. The method according to claim 1, wherein the first information indicates one or more of the following:
a first EDT radio network temporary identifier (EDT-RNTI) corresponding to the first terminal device;
a resource for a demodulation reference signal (DMRS) corresponding to the first terminal device;
an allocation scheme of the plurality of common PURs; or
a resource index in the plurality of common PURs.

4. The method according to claim 3, wherein the first EDT includes at least one of the first EDT-RNTI or the DMRS.

5. The method according to claim 1, further comprising:
sending, by the first terminal device, a configuration request to a network device;
wherein the configuration request comprises a request to the network device to send the first information.

6. The method according to claim 5, wherein the configuration request includes one or more of the following information:
capability information of the first terminal device;
a service type of the first terminal device; or
whether the first terminal device enables EDT-related configuration.

7. The method according to claim 5, wherein the configuration request further includes a first indication configured to indicate that EDT-related transmission enables acknowledgment (ACK)/negative acknowledgment (NACK) feedback.

8. The method according to claim 1, wherein an NTN cell where the first terminal device is located includes a plurality of terminal devices requesting EDT, the plurality of common PURs are allocated to the plurality of terminal devices, and the first information indicates a plurality of resources respectively corresponding to the plurality of terminal devices.

9. The method according to claim 1, wherein:
in response to the first resource being greater than or equal to a resource requested by the first terminal device, the first EDT is successful; or
in response to the first resource being less than a resource requested by the first terminal device, the first EDT is unsuccessful.

10. The method according to claim 1, further comprising:
starting, by the first terminal device, a second timer in response to the first EDT being unsuccessful; and
performing, by the first terminal device, retransmission of the first EDT or a random access procedure upon expiry of the second timer.

11. The method according to claim 1, wherein the plurality of common PURs are divided into a plurality of resource pools, the first information indicates a first resource pool where the first resource is located, and the method further comprises:
determining, by the first terminal device, the first resource in the first resource pool in a contention-based manner.

12. The method according to claim 11, wherein the first terminal device is one of a plurality of terminal devices, and the plurality of resource pools are determined according to one or more of the following information:
signal quality of configuration requests sent by the plurality of terminal devices;
coverage enhancement levels at locations of the plurality of terminal devices;
service times of the plurality of terminal devices; or
service types of the plurality of terminal devices.

13. The method according to claim 11, wherein further comprising:
determining, by the first terminal device, the first resource in the plurality of resource pools in response to a signal quality of a configuration request sent by the first terminal device being greater than a first threshold.

14. The method according to claim 11, wherein the first terminal device corresponds to a first NTN cell, the plurality of resource pools include a first resource pool and a second resource pool, a time-domain position of the first resource pool is earlier than a time-domain position of the second resource pool, and the method further includes:
determining, by the first terminal device, the first resource in the first resource pool in response to a service time of the first terminal device being outside a service time of the first NTN cell; or
determining, by the first terminal device, the first resource in the second resource pool in response to the service time of the first terminal device being within a service time of the first NTN cell.

15. The method according to claim 11, wherein an NTN cell where the first terminal device is located supports L service types, the plurality of resource pools are L resource pools, and a size of each of the L resource pools is determined according to service priority.

16. A method for wireless communication, comprising:
sending, by a network device in a non-terrestrial network (NTN), first information comprising information for determining a first resource; and
receiving, by the network device from a first terminal device, first early data transmission (EDT) on the first resource, wherein the first resource is one of a plurality of common preconfigured uplink resources (PURs), and the plurality of common PURs are configured for data transmission in the NTN.

17. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving first information;
determining a first resource based on the first information, wherein the first resource is one of a plurality of common preconfigured uplink resources (PURs), and the plurality of common PURs are configured for data transmission in a non-terrestrial network (NTN); and
sending first early data transmission (EDT) on the first resource.

18. The apparatus according to claim 17, wherein the first information is carried in a system information block (SIB) or a radio resource control (RRC) dedicated signaling.

19. The apparatus according to claim 17, wherein the first information indicates one or more of the following:
a first EDT radio network temporary identifier (EDT-RNTI) corresponding to the apparatus;
a resource for a demodulation reference signal (DMRS) corresponding to the apparatus;
an allocation scheme of the plurality of common PURs; or
a resource index in the plurality of common PURs.

20. The apparatus according to claim 19, wherein the first EDT includes at least one of the first EDT-RNTI or the DMRS.
